(19) United States
(12) Patent Application Publication
(10) Pub. No.: US 2011/0129811 A1
(43) Pub. Date: Jun. 2, 2011

(54) Cryopreservation and Storage Systems and Methods

(75) Inventor: Jun Tao, Mesa, AZ (US)

(73) Assignee: SCITECH INVENTION, LLC, Tempe, AZ (US)

(21) Appl. No.: 12/957,901

(22) Filed: Dec. 1, 2010

Related U.S. Application Data
(60) Provisional application No. 61/265,592, filed on Dec. 1, 2009.

(51) Int. Cl. A01N 1/00

(52) U.S. Cl. 435/1.3; 435/284.1

(57) ABSTRACT

Embodiments provide improved systems and methods for preservation and storage of specimens for easy loading and releasing with rapid cooling and warming rates. Embodiments provide a system including an inner device that includes a specimen support located at or near the distal end of inner device and an outer sleeve that includes a longitudinal tube and a sample retaining region defined within the longitudinal tube adjacent the distal end. The outer sleeve can be adapted to allow the specimen support of the inner device to pass into the sample retaining region and to prevent the specimen support from contacting the distal end of the outer sleeve. A guide tube may optionally be included that facilitates loading and unloading the inner device within the outer sleeve. Optionally, a magnetic force can be applied to one or more ferromagnetic members of the inner device or the outer sleeve to maneuver the same.

### RELATED APPLICATIONS

This application claims the benefit of U.S. Provisional Application No. 61/265,592 filed on Dec. 1, 2009, which is incorporated by reference herein in its entirety.

### FIELD OF THE INVENTION

The present invention relates to biological specimen preservation and storage, and more particularly to systems and methods providing cryopreservation and storage.

### BACKGROUND OF THE INVENTION

Slow freezing techniques have been used for the cryopreservation of human and animal embryos for more than two decades. During slow freezing, embryos are dehydrated by a series of solutions that contain increasing concentrations of cryoprotectants. Cryoprotectants are used to protect cells from damage caused by ice crystals that can form inside cells during freezing or thawing processes. Embryos are loaded into. small vials or straws and slowly cooled to temperatures approximating −30° C. After cooling, the embryos are plunged into liquid nitrogen. This procedure requires special equipment and usually takes about one to three hours. When the embryos are needed, a thawing procedure is performed that includes warming up the vials or straws and removing the cryoprotectants using multiple dilution steps. This slow freezing method has been proven to be sub-optimal for the cryopreservation of'embryos, and especially oocytes which have larger cell volume, as the slow freezing method cannot completely avoid ice crystal formation inside cells.

Vitrification has been studied as an alternative type of method for cryopreservation. Vitrification utilizes a higher concentration of cryoprotectants and an ultra-rapid freezing procedure to make the embryo and surrounding solution “glassified,” thus, avoiding ice crystal formation. Vitrification can result in a significantly lower incidence of physical damage to cells and embryos, and, therefore, offers a better alternative for traditional embryo and oocyte cryopreservation.

A variety of devices have been developed for vitrification. A challenge for a successful vitrification is to cool cells or embryos at a very high speed, such as at cooling rates over 10,000° C./minute or even as much as or greater than 20,000PC/minute. To reach this cooling rate, cells and embryos are vitrified in small volumes of solution, ideally less than 1 micro liter. Conventionally, copper grids, similar to those used for loading electron microscope samples, are used as an embryo carrier. When the copper grid is plunged into liquid nitrogen, the cooling rate can reach to over 20,000° C./minute, and a good survival result can be achieved. Other devices, such as a cut straw or a loop device (e.g., a nylon cryopreservation loop, etc.), may also result in improved vitrification recovery rates. However, each of the aforementioned devices suffer from a common deficiency in that they each are plunged into liquid nitrogen directly. This type of system is considered to be an “open” system. One concern is that in open systems, direct liquid nitrogen contact may cause virus contamination, or cross contamination may occur between embryos when many embryos are stored in the same liquid nitrogen tank.

To prevent contamination, several “closed” systems have recently been developed. The CRYOTIP® device, by Irvine Scientific of Santa Ana, Calif., is one example of such a device. The CRYOTIP® device is a fine straw having an inner diameter that is slightly larger than a typical embryo. After loading embryos or other specimen (usually 1 to 2 embryos), such as by using a pipette procedure, both ends of the straw are heat sealed and then plunged into liquid nitrogen. Another closed device, by MidAtlantic Diagnostics of Mount Laurel, New Jersey, has a similar structure that is also to be plunged into liquid nitrogen after sealing the end. These closed devices do provide a safe way to prevent contamination and/or cross-contamination. However, the thin segment of these devices are fragile. In addition, an embryo may be lost during the warming procedure because of the easily formed air bubbles within the devices.

Typically, a high concentration of cryoprotectants is utilized for vitrification. These cryoprotectants in high concentration, however, can be toxic to embryos when exposed to the cryoprotectants for long periods.

Therefore, there is a need to develop improved devices for use in vitrification cryopreservation and storage, and particularly devices capable of quick sample loading and removal, rapid cooling rates, and rapid warming rates.

### SUMMARY OF THE INVENTION

Embodiments of the invention provide an improved closed freezing system for vitrification and storage of specimens, such as ova and embryos, for easy specimen loading and releasing with rapid cooling and warming rates. Methods to be carried out in using the described embodiments are also provided.

Embodiments of the invention provide cryopreservation, including vitrification, and storage systems that include an inner device and an outer sleeve. An inner device may include a longitudinal body having a distal end, a proximal end, and a specimen support located at or near the distal end of the body of the inner device. An outer sleeve may include a longitudinal tube having an inner surface and an outer surface, a distal end, and an open proximal end. A sample retaining region may also be defined within the longitudinal tube adjacent the distal end. The outer sleeve can be adapted to allow the specimen support of the inner device to pass into the sample retaining region and to prevent the specimen support from contacting the distal end of the outer sleeve. According to one embodiment, the inner device is sized to fit completely within the outer sleeve.

According to one embodiment, the outer sleeve may include at least one protruding member on the inner surface that allows the specimen support of the inner device to pass into the sample retaining region and prevents at least a portion of the body of the inner device proximal from the specimen support from passing into the sample retaining region. Accordingly, the sample retaining region exists between the at least one protruding member and the distal end of the outer sleeve. The at least one protruding member reduces at least a portion of the inner diameter of the outer sleeve at the location of the at least one protruding member, and the reduced inner diameter is less than the outer diameter of at least a portion of the body of the inner device proximal from the specimen support to prevent that portion of the body from passing thereby.

According to certain embodiments, the outer sleeve may further include one or more weighted members proximate the distal end. In one embodiment, the weighted members are ferromagnetic to facilitate manipulation of the outer sleeve when a magnetic force is applied thereto. According to certain embodiments, the inner device may also, or instead, include one or more weighted members and/or one or more ferromagnetic members.

According to one embodiment, the specimen support of the inner device may include a loop for collecting specimen. At least a portion of the loop is adapted to pass into the sample retaining region and does not contact the distal end of the outer sleeve.

According to another embodiment, the specimen support of the inner device may include a tapered distal end. The tapered distal end may further include a recessed area for collecting specimen. In some embodiments, the recessed area may form at least one groove, wherein the at least one groove is approximately perpendicular to a longitudinal axis defined by the longitudinal body of the inner device. The tapered distal end can be adapted to pass into the sample retaining region and to not contact the distal end of the outer sleeve.

According to certain embodiments, a guide may further be provided. A guide may include a longitudinal guide tube having an open distal end and an open proximal end. The distal end of the guide tube defines a first inner diameter equal to or greater than an outer diameter of the proximal end of the outer sleeve and the proximal end of the guide tube defines a second inner diameter greater than an outer diameter of the inner device. The second inner diameter is smaller than the outer diameter of the proximal end of the outer sleeve, according to one embodiment. The first inner diameter of the guide tube allows the outer sleeve to be inserted into the distal end of the guide tube and slide within the guide tube until restricted by the second inner diameter. The first inner diameter and the second inner diameter of the guide tube allow the inner device to be inserted into the distal end of the guide tube and slide freely through and at least partially extend through the proximate end of the guide tube.

Embodiments of the invention also can provide cryopreservation and storage methods. According to one embodiment, a cryopreservation and storage method may include: providing an inner device having a longitudinal body having a distal end, a proximal end, and a specimen support located at the distal end of the body of the inner device; and providing an outer sleeve comprising a longitudinal tube having an inner surface and an outer surface, a distal end, and an open proximal end, and a sample retaining region defined within the longitudinal tube adjacent the distal end. The method may further include: collecting at least one specimen from solution with the specimen support of the inner device; inserting the distal end of the inner device into the proximal end of the outer sleeve, wherein the outer sleeve is adapted to allow the specimen support of the inner device to pass into the sample retaining region and to prevent the specimen support from contacting the distal end of the outer sleeve; sealing the proximal end and the distal end of the outer sleeve; and transferring the sealed outer sleeve containing the inner device retaining the specimen into storage medium.

According to one embodiment, the method may further include cooling the outer sleeve prior to inserting the inner device therein.

According to one embodiment, the inner device can be initially provided within the outer sleeve. The method may therefore further include: coupling a distal end of a guide tube onto the proximal end of the outer sleeve; and, prior to collecting the at least one specimen, removing the outer sleeve from the distal end of the guide tube.

According to other embodiments, a method may additional include removing an inner device from storage medium for warming. The method may include: removing a proximal end of an outer sleeve containing the inner device from the storage medium, leaving the rest of the system immersed in the storage solution, including the remaining portion of the outer sleeve and the inner device contained therein; opening the proximal end of the outer sleeve; coupling a distal end of a guide tube to the proximal end of the outer sleeve; sliding the inner device out of the proximal end of the outer sleeve and into the guide tube so that the specimen support is positioned within the guide tube; uncoupling the guide from the outer sleeve; and sliding the inner device distally to extend at least partially out of the guide tube to release the specimen from the specimen support to a thawing or warming solution. In some embodiments, the guide tube may not be utilized such that the inner device is removed directly from the outer sleeve for immediate transfer to a thawing solution.

According to certain embodiments, a magnetic force can be applied to at least one ferromagnetic member associated with the inner device and/or the outer sleeve to facilitate maneuvering the inner device and/or the outer sleeve.

Additional systems, methods, apparatus, features, and aspects may be realized through the techniques of various embodiments of the invention. Other embodiments and aspects of the invention are described in detail herein with reference to the description and to the drawings and are considered a part of the claimed invention.

### BRIEF DESCRIPTION OF THE DRAWINGS

FIG. 1 illustrates a top view of an outer sleeve, according to an example embodiment.

FIG. 2 illustrates a top view of an inner device, according to an example embodiment.

FIG. 3 illustrates a top view of a guide, according to an example embodiment.

FIG. 4 illustrates a top view of a system including an inner device inside of an outer sleeve, according to an example embodiment.

FIG. 5 illustrates a top view of an inner device within a guide prior to attachment to an outer sleeve, according to an example embodiment.

FIG. 6 illustrates top and side views of a tapered distal end of an inner device, according to an example embodiment.

FIG. 7 illustrates a side view of a tapered distal end of an inner device passing through protrusions of an outer sleeve, according to an example embodiment.

### DETAILED DESCRIPTION OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The embodiments described herein provide improved cellular specimen removal, preservation, and storage systems, such as for mammalian ovum and/or embryos. These embodiments achieve increased cellular survival rates during preservation and storage. As part of the preservation and storage process, the system including a specimen is deposited into a storage medium to provide rapid cooling and preservation environment. As used herein, the term “storage medium” may refer to any medium suitable for providing extreme cool temperatures, such as, but not limited to, liquid nitrogen or any other suitable liquid, gas, or solid substance. In many cases, it is desirable to complete cellular loading during the freezing and storage process, and complete cellular releasing during the warming process, rapidly so as to increase cellular survival. Accordingly, the embodiments described herein provide cryopreservation, which includes vitrification, and storage devices capable of quickly loading cells and securing them prior to freezing, and quickly removing the cells from the device to provide a rapid warming rate.

According to an example embodiment, a cell cryopreservation and storage system includes: an inner device, an outer sleeve, and, optionally, a guide. Briefly, the inner device has a longitudinal body with a cellular specimen support located at or near its distal end. The outer sleeve has a longitudinal tube defining an inner surface and an outer surface. The inner device is retained within the outer sleeve during transportation and storage. A sample retaining region is located within the longitudinal tube and adjacent or proximate the distal end of the outer sleeve. The sample retaining region is defined by one or more protruding members that extend inward and reduce the inner diameter of the outer sleeve. Thus, in this embodiment, the cellular specimen support of the inner device can pass into the sample retaining region of the outer sleeve without contacting the inner surface and the distal end of the outer sleeve. The configuration of the protruding members and the shape and size of the inner device allow only the cellular specimen support, or a portion thereof, to extend into the sample retaining region, and thus provide a secure space for protecting the specimens. The outer sleeve can be sealed at its distal end, providing additional security to the specimen when contained therein and improving the cooling effects of the outer sleeve.

A guide can also be provided, which also includes a longitudinal guide tube having open ends. According to one embodiment, the guide tube is configured to allow the inner device to slide freely within guide tube, but restrict the outer sleeve from passing beyond a point near the guide tube's proximal end. The guide, therefore, provides a unique assembly for aligning and loading the inner device within the outer sleeve, as well as for facilitating the transfer of the inner device. In some instances, the guide can serve to maintain cooled temperatures surrounding the specimen during removal from the storage medium and transportation to a warming or thawing solution. The guide can maintain cooled temperatures by being placed on the open end of an outer sleeve for a period of time (e.g., 2-15 seconds or more) while at least a portion of the outer sleeve (e.g., its distal end) remains in the storage medium. Thus, the extreme cold temperatures from the storage medium cool the area within the guide prior to extracting the inner device and holding the specimen therein.

According to some example embodiments, the cryopreservation and storage system may further include a loop extending from the tip of the inner device. The loop can be used to collect and store a specimen, such as may be loaded using a pipette to retrieve the specimen from solution. The loop is sized to pass freely and unobstructed into the sample retaining region. In other example embodiments, however, the inner device can be configured with a tapered distal end (or any other desirable geometry) forming a surface for contacting and storing a specimen, such as a groove or other recessed area. In one embodiment, a region of the tapered distal end can have a highly smoothed surface to ease transfer of the specimen into a warming solution. A pipette or other loading technique may also be utilized to load an inner device having a tapered distal end. The tapered distal end can also be shaped and sized to pass at least partially into the sample retaining region, while the rest of the inner device body is restricted.

The cryopreservation and storage system may also include one or more members formed from metal or other ferromagnetic materials embedded at or near the proximal end of the inner device and/or at or near the distal end of the outer sleeve. The metal or other ferromagnetic pieces in the inner device allow using a magnetic element to facilitate insertion and retrieval of the inner device within the outer sleeve. The metal or other ferromagnetic pieces in the outer sleeve may likewise allow manipulating the outer sleeve, such as when in storage media, as well as to serve as a weight that prevents the inner device from floating when held in the storage media. In addition, the same or different metal members may serve as a weight to prevent floating and retain the devices within solution during storage.

Embodiments of the invention further provide methods for performing cryopreservation and storage of cellular specimens using the cryopreservation and storage system described above. The methods may include a cryopreservation and procedure for rapid collection and movement of cellular specimens within a protective sleeve and into a cooling and storage medium, in addition to a warming procedure that includes removal from the storage medium. Generally describing an example vitrification method, the cellular support Component of the inner device is removed from the outer sleeve, which can be pre-cooled using liquid nitrogen or other cooling agent, to collect cellular specimens from vitrification solution. After loading the specimen, the cellular specimen support can be quickly pulled into a protective guide to protect the specimen during insertion into the outer sleeve. The guide can further facilitate secure and careful insertion of the inner device into the outer sleeve so as to not disturb the specimen support. Once the inner device with the specimen is fully inserted into the outer sleeve, the sleeve is sealed just before being deposited into a liquid nitrogen tank for long term storage. The methods may also include using the cryopreservation and storage system for removing the specimen from storage and transporting the specimen to a warming dish containing cryoprotectants for thawing. The configuration of the cryopreservation and storage system, thus, allows for rapid cooling and rapid warming, due to its protective nature and simple operation for collecting or disposing of cellular specimens.

Among its many advantages, the cryopreservation and storage system allows for rapid cooling during the vitrification process and rapid warming during the warming process. Pre-cooling the outer sleeve prior to inserting the inner device containing a specimen inside the outer sleeve reduces the temperature variance when submitting the sealed outer sleeve containing the inner device into liquid nitrogen or other storage media. Also, for embodiments using a loop to collect cellular specimens, the loop allows for quicker cooling rates because of its reduced mass (as compared to a solid structure). Likewise, more rapid warming can be achieved because a cooled guide retaining the inner device can serve as a cooling chamber to keep the cellular specimen cool when transferring the specimen from the storage solution, removing it from the outer sleeve and depositing into a warming solution.

In addition, the cryopreservation and storage system improves handling of the individual components and manipulation of the cellular specimen. For example, the guide tube provides simple and safe alignment of the inner device within the outer sleeve during insertion and removal to avoid disturbing the retained specimen. Additionally, the protruding members within the outer sleeve create a secure sample preserving region between the protruding members and the distal end of the sleeve that minimizes disturbance of the cellular specimens during transportation and storage. The combination of the reduced inner diameter of the outer sleeve caused by the recessed members and the configuration of the inner device, which is restricted by the recessed members except for the cellular specimen support, defines the sample preserving region within the outer sleeve. Suspending the specimen within this sample region further facilitates rapid cooling when placed within the cooling medium. Maneuvering the inner device can also simplified by using applying a magnetic force to one or more ferromagnetic members secured to or otherwise associated with the inner device and/or the outer sleeve. Using magnetism improves the manipulation of the inner device when within the cooling sleeve and/or the guide, as well as facilitates maneuvering or removal of the sleeve containing the inner device from solution.

These and other advantages of the cryopreservation and storage systems and methods will become apparent in light of the detailed example embodiments of the invention, which are described below with reference to the drawings.

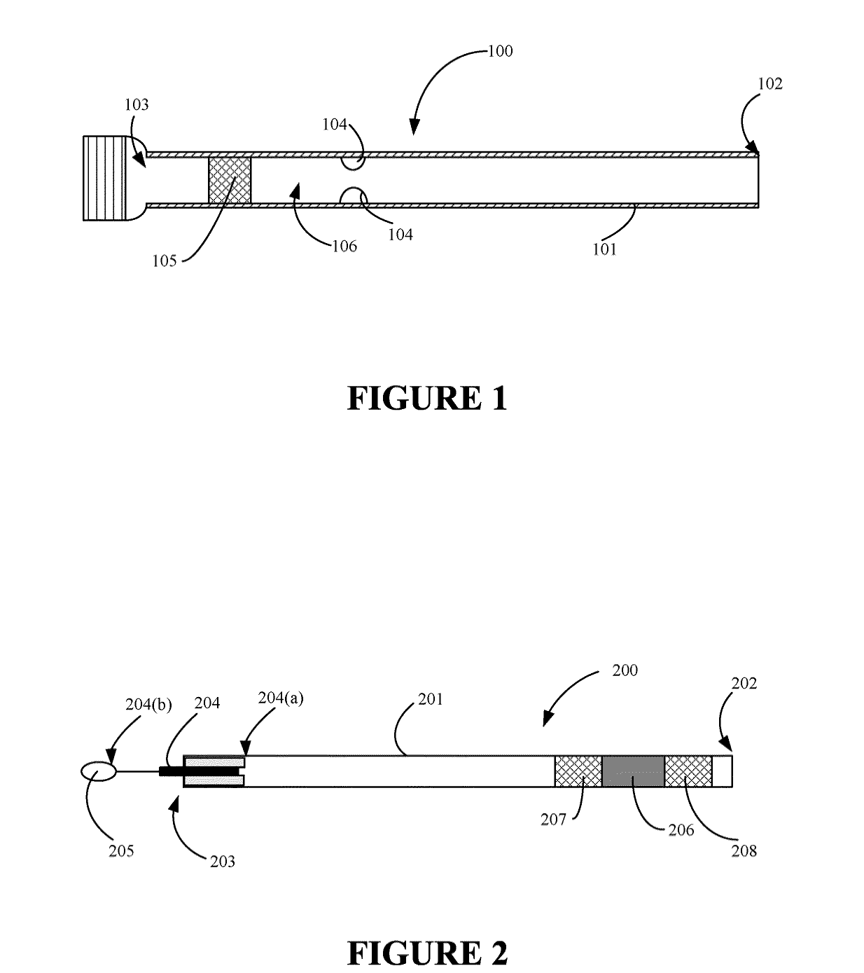

FIG. 1 is a perspective view showing an outer sleeve 100 of a cryopreservation and storage system, according to one embodiment of the invention. As described above, the outer sleeve 100 is utilized to store and protect an inner device containing specimen during storage, such as within liquid nitrogen. The outer sleeve 100 may be formed as a longitudinal tube 101 having an inner surface and an outer surface. The tube 101 includes an open proximal end 102, a distal end 103, both of which may be sealed or selectively sealable at some instance during the procedure, and a sample retaining region 106. The proximal end 102 is retained open until the inner device 200 with embryo loaded is inserted into the outer sleeve 100. The distal end 103 of the outer sleeve 100 can be sealed using a number of techniques. In one example, heat can be supplied to seal the distal end 103, such as by a heat crimping iron, a heated tip, or other heat applying techniques suitable for fusing (e.g., melting) the end. Other selective sealing techniques can include, but are not limited to, electricity, chemical (e.g., adhesive, chemical bonding, etc.), mechanical (e.g., crimping, clamps, caps, etc.), electro-mechanical, electro-chemical, or any combination thereof. Likewise, after insertion of the inner device 200, described by example with reference to FIG. 2, within the outer sleeve 100, the proximal end 102 of the outer sleeve 100 is sealed using any of these techniques or other suitable sealing techniques. For example, FIG. 4, which is described in more detail herein, illustrates a cap 402 slideably positioned over, or otherwise coupled to, the proximal end 102 of the outer sleeve 100.

According to certain embodiments, one or more protruding members 104 are provided at a distance away from the distal end 103 of the outer sleeve 100. The protruding members 104 protrude inwardly and define a sample retaining region 106 within the sleeve 100 between the distal end 103 and the location of the protruding members 104 by preventing passage into the sample retaining region 106 for all but the cellular specimen support of the inner device. For example, in the embodiment shown, at least two protruding members 104 are provided within approximately 2-5 cm from the distal end 103. The protruding members 104 reduce the inner diameter of the longitudinal tube 101 at that location to prevent at least a portion of the inner device 200 from passing therethrough, while allowing the cellular specimen support 204 of the inner device 200 to pass into the sample retaining region 106 without contacting the distal end 103 of the outer sleeve 100. Other protruding members 104 may be configured as one or more round protrusions, elongated protrusions, annular-shaped protrusions (e.g., disc or washer-like member, etc.), or any other shaped member extending into or otherwise reducing the inner diameter of the outer sleeve 100 and assisting to define the sample retaining region 106 and to prevent at least a portion of the body of the inner device 200 proximal from the specimen support 204 from passing into the retaining region 106.

Optionally, the longitudinal tube 101 of the outer sleeve 100 may also include at least one weighted material 105 located at or near the sealed distal end 103. The weighted material 105 may be affixed to the outer or inner surfaces of the tube 101, or may be integrated within the tube 101 wall. The weighted material 105 serves to prevent the distal end of the outer sleeve 100 from floating in storage medium (e.g., liquid nitrogen, etc.) when placed therein, thus retaining the specimen contained within the sample retaining region 106 in the storage medium. According to one embodiment, the weighted material 105 can be constructed from a metal. However, any weight contributing materials can be positioned inside of the longitudinal tube 101, such as, but not limited to, high density natural or synthetic polymers or alloys. The weighted material 105 (or another material applied to the outer sleeve 100) may also be ferromagnetic, which allows applying a magnetic force to maneuver the outer sleeve.

The full length of the longitudinal tube 101 of the outer sleeve 100 can be between approximately 10 cm and 20 cm, including 10 cm, 12 cm, 13 cm, 15 cm, or 20 cm, according to various embodiments. The inner diameter of the longitudinal hollow tube 101 of the outer sleeve 100 can range between approximately 1.0 mm and 5.0 mm, including 1.0 mm, 2.0 mm, 3.0 mm, 4.0 mm, or 5.0 mm, according to various embodiments. The wall thickness of the longitudinal tube 101 of the outer sleeve 100 can range between 10 microns and 500 microns, according to various embodiments. It is appreciated that the aforementioned dimensions (and any other dimensions provided herein) are provided for illustrative purposes, and that any of these dimensions may be altered to values greater or less than that stated, which may vary depending upon the intended application, without departing from the invention.

FIG. 2 shows a perspective view of an inner device 200 for use with a . cryopreservation and storage system, according to an example embodiment of the invention. As the name implies, the inner device 200 is intended for insertion within the outer sleeve 100, and used to collect and retain one or more specimens prior to insertion within the outer sleeve 100 for storage. The inner device 200 is formed from a longitudinal body 201 having a proximal end 202 and a distal end 203.

A specimen support may extend from the distal end 203 of the inner device for collecting and retaining a specimen and storing within the sample retaining region 106. For example, a pipette procedure may be utilized to load a specimen from solution into the specimen support prior to storage. According to one embodiment, the cellular specimen support 204 can be configured as an elongated member extending from the body 201 and optionally including a loop 205. For example, according to one embodiment, the a proximal end 204a of the cellular specimen support 204 may extend from within, or otherwise be affixed to, the distal end 203 of the inner device 200 with a distal end 204b of the cellular specimen support 204 (optionally containing a loop 205) extending from the longitudinal body 201. According to various embodiments, the distal end 204b of the cellular specimen support 204 may extend from the inner device 200 approximately 1 mm to 2 mm; though, it may extend farther or less in other embodiments. The cellular specimen support 204 can be constructed from any type of suitable materials, including, but not limited to, metals, natural or synthetic polymers, or any combination thereof. According to one embodiment, the cellular specimen support 204 may optionally be surrounded by or wrapped with one or more weighted materials, also serving to prevent the cellular specimen support 204 from floating in storage media.

According to one embodiment, the cellular specimen support 204 may further include a contact loop 205 at its distal end 204b. The contact loop 205 thus can extend from the inner device 200 for contacting the specimen. The contact loop 205 can be constructed from any type of suitable materials, including, but not limited to, nylon or other synthetic or natural polymers, metals, alloys, and the like. A contact loop 205 further serves to increase the rate of cooling during the vitrification procedure due to its minimized mass. The contact loop 205 may have a diameter ranging between approximately 0.1 mm and 1.0 mm, including 0.1 mm, 0.2 mm 0.3 mm, 0.4 mm, 0.5 mm, 0.6 mm, 0.7 mm, 0.8 mm, 0.9 mm, or 1.0 mm, according to various embodiments. For example, in one embodiment, the diameter of the contact loop 205 may be approximately 0.3 mm to 0.7 mm.

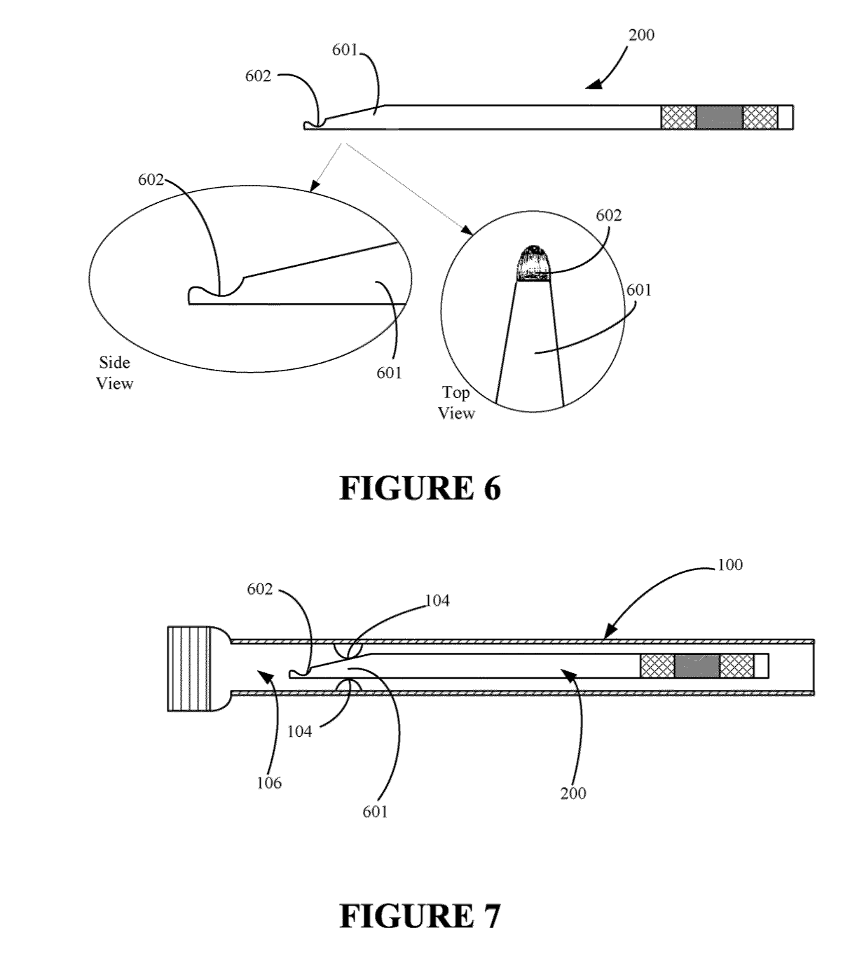

In other embodiments, such as are illustrated in FIGS. 6 and 7, the inner device 200 may include a tapered distal end 601 forming a surface for contacting and storing a specimen. According to one embodiment, the tapered distal end 601 may include one or more recessed areas or indentations 602 for receiving the cellular specimens. The shape and size of the recessed area 602 may vary, such as, but not limited to, substantially round, ovular, linear grooves, longitudinal grooves, and the like.

According to one embodiment, the surface of the recessed area 602 may be have a smoothed surface to reduce friction and facilitate releasing specimen from the area 602 during the thawing stages. In one embodiment, the smoothed surface of the recessed area 602 may be formed during manufacturing by applying the distal end of the longitudinal body of the inner device 200 to a heated glass surface (or other suitable heated member having a substantially smoothed surface) having the desired geometry (e.g., curved, flat, etc.), which acts to molds the tip of the inner device 200 into the recessed area 602. In this example embodiment, the inner device 200 may be formed from a plastic tube or rod, or form any other suitable material having a relative melting point lower than the heated glass used. Because the heated glass has an extremely smooth surface, heating the inner device by the heated glass will create a similarly smoothed surface within the recessed area 602. In other embodiments, however, the recessed area 602 may be smoothed utilizing other suitable techniques, such as, but not limited to, polishing, coating, and the like. Accordingly, when describing the distal end of an inner device 200 having a smoothed end, it is appreciated that “smooth” can refer to any surface having a reduced surface roughness or substantially free or frictional impediments, or any surface that exhibits a coefficient of friction less than surrounding surfaces (e.g., the recessed area 602 may have a coefficient of friction less than other surfaces of the inner device), or any surface that is formed according to the smoothing techniques described herein.

Also shown by FIG. 6 are magnified partial side and top views of the tapered distal end 601, illustrating an example configuration for the taper and the recessed area 602. It is appreciated that, in other embodiments, the tapered distal end 601 may have a different configuration than that shown, such as different tapering angles relative to the longitudinal body of the inner device 200, different tip shapes, different recessed area 602 shapes or orientations. For example, the recessed area 602 may form a flat or substantially flat surface, may form a concave or substantially concave area, may form multiple channels, and the like.

According to one embodiment, a recessed area 602 can be defined as grooves that are oriented approximately perpendicular to the longitudinal axis of the inner device 200, which facilitates quick removal of specimen into a warming solution by horizontal movement of the tip within the solution. It can be advantageous to improve upon the ability to release the cell specimen because thawing solution is typically expensive and thus provided in very small quantities (e.g., 10-50 micro liters). Therefore, quickly releasing the specimen with slight movement is particularly advantageous to improve warming rates and to avoid requiring larger quantities of thawing solution.

As shown in FIG. 7, at least a portion of the tapered distal end 601 is adapted to pass into the sample retaining region 106 in the outer sleeve 100 without contacting the distal end 103 of the outer sleeve 100, with the remaining portion of the inner device 200 being restrained by the one or more protruding members 104 extending inwardly within the outer sleeve 100.

With continued reference to FIG. 2, one or more metal or other ferromagnetic members 206 may also be placed at or near the proximal end 202 of the longitudinal body 201 of the inner device 200, optionally with one or more weighted materials 207, 208. The ferromagnetic members 206 and/or the weighted materials 207, 208 may be utilized to allow retrieving the inner device 200 from the outer sleeve 100 by applying a magnetic force. Accordingly, in some embodiments an additional magnetic tool may be provided to use with the system for maneuvering the inner device 200 and/or the outer sleeve. Similarly, the ferromagnetic members 206 and/or the weighted materials 207, 208 may also prevent the inner device 200 from floating when in a storage medium (e.g., liquid nitrogen, etc.). The ferromagnetic members 206 and the weighted materials 207, 208 can be made of any metal or other ferromagnetic materials, including, but not limited to iron, copper, nickel, or any other suitable ferromagnetic materials.

According to one embodiment, the full length of the longitudinal body 201 of the inner device 200 can be shorter than the longitudinal tube 101 of the outer sleeve 100, and its outer diameter smaller than the inner diameter of the longitudinal tube 101 of the outer sleeve 100. These relative dimensions allow the inner device 200 to slide freely within at least a portion of the outer sleeve 100, until stopped at the location of the protruding members 104. Limiting further passage of the inner device 200 within the outer sleeve 100 leaves the contact loop 205 free from touching the inner surface of the distal end 103 of the outer sleeve 100.

Therefore, depending on the full length and the inner diameter of the outer sleeve 100, the full length of the inner device 200 can range between about 5 cm and 10 cm, including 5 cm, 6 cm, 7 cm, 8 cm, 9 cm, or 10 cm, according to various embodiments. The outer diameter of the inner device 200 can range between about 0.5 mm and 2.5 mm, including 0.5 mm, 0.6 mm, 0.7 mm, 0.9 mm, 1.0 mm, 1.5 mm, 2.0 mm, or 2.5 mm, according to various embodiments. Similarly, the wall thickness of the longitudinal body 201 of the inner device 200 can be between approximately 5 microns and 250 microns, according to various embodiments.

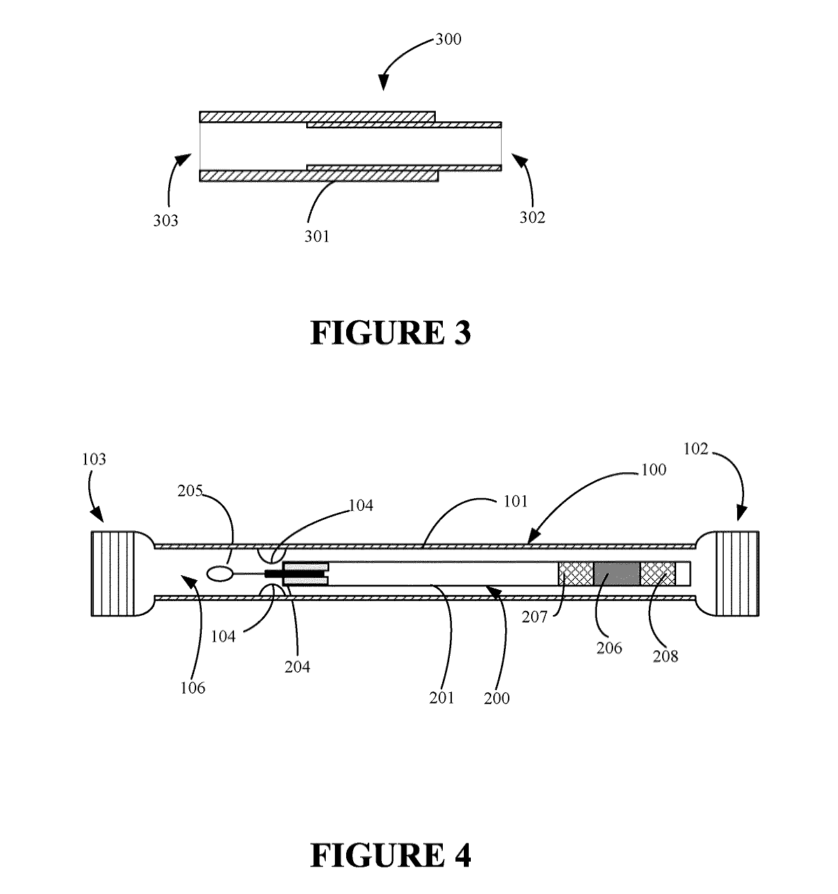

FIG. 3 is a perspective view of a guide 300, according to one embodiment of the invention. The guide 300 includes a longitudinal guide tube 301 having an open proximal end 302 and an open distal end 303. The distal end 303 of the guide 300 has an inner diameter that is larger than the outer diameter of the proximal end 102 of the outer sleeve 100, which allows the outer sleeve to slide into and within the distal end 303 of the guide tube 301. Likewise, the distal end 303 inner diameter is close to the same as or only slightly larger than that of the proximal end 102 of the outer sleeve 100 to provide a tight fit between the two bodies and to minimize play or lateral or pivotal movement when the sleeve 100 is inserted within the guide 300. Minimizing lateral or pivotal movement may be beneficial to avoid disturbing the specimen when the inner device 200 is inserted through the guide 300 and into the outer sleeve 100. Likewise, the proximal end 302 of the guide tube 301 has a diameter that is larger than the outer diameter of the inner device body 201, which allows the inner device 200 to slide freely within the guide tube 301. However, this inner diameter of the proximal end 302 is smaller than the inner diameter at the distal end 303, which, according to one embodiment, prevents the outer sleeve 100 from passing into the proximal end 302 and allows the guide 300 to be capped or coupled to the outer sleeve 100.

The guide 300 may also serve as a cold chamber during removal and thawing procedures. Prior to removing an inner device 200 from an outer sleeve 100, a guide 300 is placed over the proximal end 102 of the outer sleeve 100 for at least a short period of time, such as, but not limited to, five to thirty seconds. Keeping the guide 300 on the outer sleeve 100 for this time cools the guide 300, such that when the inner device 200 is pulled through the outer sleeve 100 and into the guide 300, the specimen retained by the inner device 200 does not contact room temperature air but is instead immediately retained within the cooled guide 300. When near the thawing solution, the inner device 200 can be quickly extended from the guide 300 for immediate deposit of the specimen into the thawing solution to achieve rapid warming, thus minimizing loss. Without the guide 300, and without pre-cooling the guide 300, the specimen may undergo less optimum thawing upon exposure to room temperature air. It is appreciated, however, that use of the guide 300 is not required during thawing, and that in some embodiments the inner device 200 may be removed directly from the outer sleeve 100 and transported immediately to the thawing solution.

According to one embodiment, the full length of the longitudinal tube 301 of the guide 300 is approximately one-half of the full length of the longitudinal tube 101 of the outer sleeve 100. For example, in certain embodiments, the full length of the guide tube 301 can range between approximately 5 cm to 10 cm, including 5 cm, 6 cm, 7 cm, 8 cm, 9 cm, or 10 cm. Likewise, the wall thickness of the guide tube 301 can be thicker than or equal to the thickness of the longitudinal tube 101 of the outer sleeve 100, according to certain embodiments. It is appreciated, however, that in other embodiments, the wall thicknesses and the relative lengths may differ.

FIG. 4 shows a perspective view of the cryopreservation and storage system, according to one example embodiment of the invention. The system 400 shown includes an outer sleeve 100 with protruding members 104, such as is described with reference to FIG. 1, and an inner device 200, such as is described with reference to FIG. 2, inserted therein. The inner device 200 of this embodiment includes a cellular specimen support 204 with a contact loop 205 extending therefrom. The inner device 200 is placed inside the outer sleeve 100 with the two ends of the outer sleeve 100 being sealed. The distal end 103 is shown as being heat sealed, though any other sealing techniques described herein may be utilized. The proximal end 102 may be sealed after inserting the inner device 200 therein, such as by using a heat seal, or any other sealing techniques. The cellular specimen support 204 and loop 205 extend into the sample retaining region 106 of the outer sleeve 100 without contacting the inner surface or the distal end 103 of the outer sleeve 100. The remaining portion of the inner device body 201, proximal from the specimen support 204 (or at least a portion of the specimen support 204), is restricted by the protruding members 104, thus, retaining the specimen securely in the sample retaining region 106. The system illustrated in FIG. 4 is shown at the stage ready for storage, such as for storage in liquid nitrogen.

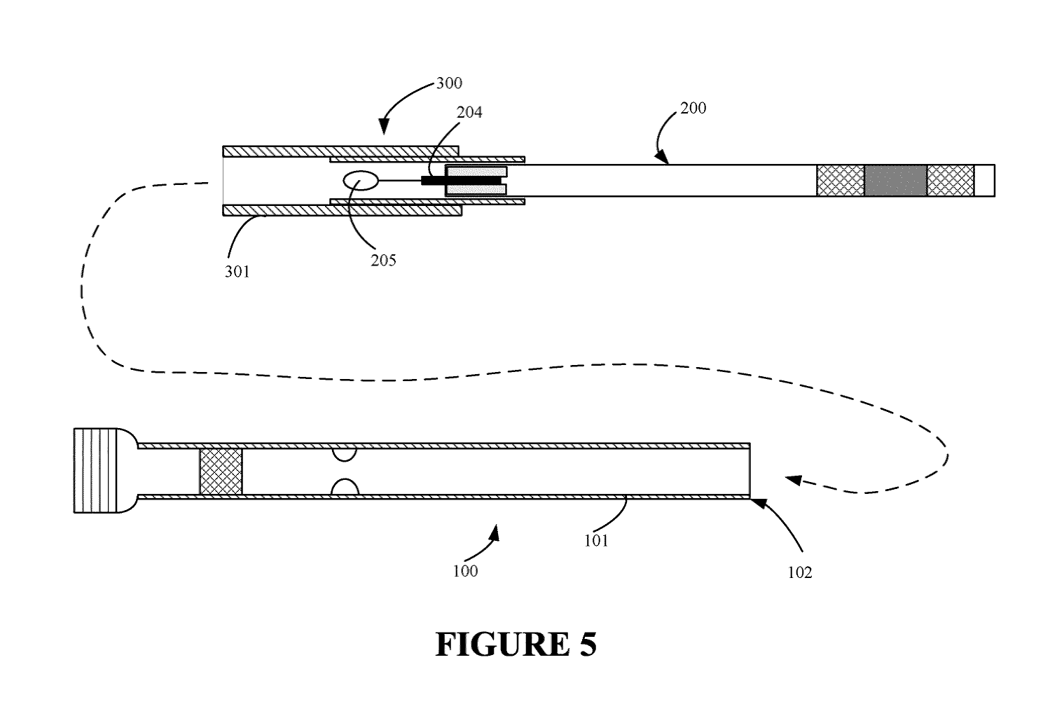

FIG. 5 shows a perspective view of the inner device 200 pulled through a guide tube 301 until the nylon loop 205 extends to or near the middle of the guide tube 301. At this position, the outer sleeve 100 and is ready to be provided by pushing the inner device 200 into the outer sleeve 100 until restricted at or near the protruding members 104 in the outer sleeve 100. Such an arrangement allows the loop 205 or other aspect of the cellular specimen support 204 to be undisturbed when loaded with ovum, embryos, or other cellular specimens. This arrangement may be utilized after loading the inner device 200 with a specimen and to facilitate safe insertion of the inner device 200 into the outer sleeve 100 without disturbing the specimen. As such, after loading the inner device 200 with a specimen, the proximal end of the inner device 200 would be inserted through the distal end of the guide 300 until the contact loop 205 (or other specimen support) is securely within the guide 300, as shown. After inserting the inner device 200 into the guide 300, the outer sleeve 100 is inserted into the distal end of the guide 300 to allow careful and controlled insertion of the inner device 200 through the guide 300 and into the outer sleeve 100.

According to various embodiments, the longitudinal tube 101 of the outer sleeve 100, the guide tube 301, and the inner device body 201 can be constructed from the liquid nitrogen-resistant materials, including, but not limited to, thermoplastic resin, such as polyester, polyethylene, terephthalate, or polybutylene terephthalate; polyolefin, such as polyethylene, ultra-high-molecular-weight polyethylene, polypropylene, ethylene-prolylene copolymer, or ethylene-vinyl acetate copolymer; styrene resin, such as polystyrene, methacrylate-styrene copolymer, or methacrylate-butylene-styrene copolymer; polyamide; or any combination or combinations thereof. Methods of making the longitudinal hollow tubes with inserts are well known in the art.

Methods for vitrification and storage of cellular specimens, such as ova or embryos, can be carried out by using any of the above-described cryopreservation and storage systems. In addition, the above-described cryopreservation and storage systems can be utilized during removal of preserved specimen and thawing.

Vitrification Procedure

According to one example embodiment for vitrification or other cryogenic preservation of a specimen, the system is provided with the inner device 200 positioned within the outer sleeve 100 to protect the cellular specimen support 204. A patient's name or other identification can be labeled on the outside of the outer sleeve 100. The distal end of the guide 300 is attached to the proximal end (e.g., the open end) of the outer sleeve 100. The inner device 200 is carefully withdrawn from the outer sleeve 100 and inserted from the proximal direction and into the proximal end 303 of the guide 300.

In one embodiment, a magnetic force may be applied to the inner device to withdraw the inner device 200 from the outer sleeve 100. The inner device 200 may extend partially from the proximal end of the guide tube 300. While the loop 205 (or other aspect of the cellular specimen support 204) at the distal tip of the inner device remains securely within the guide 300, the outer sleeve 100 is removed and set aside. The inner device 200 is then moved distally through the guide 300 until the distal end of the inner device 200 extends out from the distal end of the guide tube 300, for example approximately 2 cm. The inner device 200 is then removed from the guide 300 and placed at a safe location where the loop 205 or other aspect of the cellular specimen support 204 will not be touched or otherwise disturbed.

Just before the embryo or other sample is loaded on to the loop 204 or other specimen support, the outer sleeve 100, with its distal end (the sealed end) down, can be inserted into liquid nitrogen to pre-cool the outer sleeve 100. The outer sleeve 100 can remain in the liquid nitrogen for a given period of time, such as for at least 20 seconds, for pre-cooling before loading the inner device 200 therein, according to one embodiment. The embryo or other cellular specimen(s) are then transferred from vitrification solution and loaded to the loop 205 or other specimen support, such as by using a pipette and a minimum volume of solution, for example, less than 1 micro liter. The outer sleeve 100 is pulled from the liquid nitrogen to check whether condensation of liquid nitrogen has occurred within the outer sleeve, such as at or near the distal end. If there is condensation, the outer sleeve 100 can be turned upside down to pour out the condensation before the outer sleeve 100 placed back into liquid nitrogen. Otherwise, condensation of liquid nitrogen remaining in the outer sleeve 100 may cause a sealed outer sleeve 100 to explode during the warming process. It is appreciated that, in other embodiments, the outer sleeve 100 may not be pre-cooled prior to loading the inner device 200 therein.

Next, the proximal end of the inner device 200, opposite the loop 205, is inserted into the distal end of the guide 300 until the loop 205 is positioned within the protective guide. The guide 300 is then placed on the proximal end of the outer sleeve 100. The inner device 200 is allowed to slide down from the distal end of the guide 300 and into the proximal end of the outer sleeve 100, stopped by the protruding members of the outer sleeve 100. Another method may use a magnet applied near a ferromagnetic member of the inner device 200 to carefully control the speed of the sliding inner device 200. Finally, the proximate top end of the outer sleeve 100 is quickly sealed, such as by applying a heat sealing technique, a cap, or any other sealing technique described herein. After sealing, the whole set (without the guide 300) can be moved to a liquid nitrogen tank for long term storage.

In embodiments including a tapered distal end 601 and recessed area 602, such as are described with reference to FIGS. 6 and 7, a guide 300 may not be utilized. If a guide 300 is not utilized, after loading the specimen directly to the recessed area 602 of the inner device 200, the inner device 200 is inserted directly into the proximal end of the outer sleeve 100, which is then immediately sealed and deposited into the cooling medium.

Warming Procedure

One example embodiment for warming a preserved cellular specimen is now described. One or more dishes containing warming solution drops at different concentrations of cryoprotectants can be prepared, allowing for a series of dilutions to be performed. The dish is placed close to a liquid nitrogen reservoir to allow quick transportation of the cellular specimen. After confirming the identities, the system including the inner device 200 within a sealed outer sleeve 100 (and without the guide 300) is removed from the liquid nitrogen storage medium, such as to a reservoir or other device holder. The device is maintained in an upright position with the proximal end of the outer sleeve 100 extending upwards into the air and the remaining part of the device submerged in the liquid nitrogen. The proximal top end of the outer sleeve 100 is then cut open and capped with the distal end of the guide 300. After a short period of time, for example, about 5 to 15 seconds, allowing the guide to cool, a magnet is positioned near the proximal end of the outer sleeve 100 where the ferromagnetic member (e.g., an iron piece) of the inner device 200 is located, and the inner device is pulled up towards the proximal end of the guide 300 until the distal end of the inner device 200 (e.g., at or near the loop 205) is securely within the approximate middle of the guide 300 (or other preconfigured area). The guide 300 is held by the inner device 200 and pulled from the outer sleeve 100, and then quickly transferred to the warming dish. When near the warming dish, the inner device 200 is pushed from the distal end of the guide 300 and the embryo or other cellular specimen is immediately released into the warming solution by touching the loop 205 or specimen support 204 to the warming solution.

Accordingly, embodiments described herein provide improved cell freezing systems for cryopreservation and storage of cellular specimens, such as for mammalian ova and embryos, having a number of advantages. A fast cooling rate can be achieved by allowing pre-cooling of the outer sleeve before loading the inner device. These embodiments also provide an easy method for loading the inner device into the outer sleeve. With the assistance of the guide, it is very easy and safe to insert the inner device into the outer sleeve. These embodiments further provide easy labeling and storage, because the outer sleeves can be similar to a routine 0.5 ml freezing straw, providing sufficient space for labeling. Furthermore, because the outer sleeves are similar to a routine 0.5 ml freezing straw, they can be stored in a conventional liquid nitrogen tank with little or no modification. Many standard liquid nitrogen tanks are designed to store 0.5 ml freezing straws. These embodiments further provide an easy method to retrieve an inner device during the warming process using the metal embedded in the proximal end of the inner device and a magnet.

Furthermore, the devices and systems described herein allow for a fast warming rate. Because the guide can become cold after being capped on the proximal end of the outer sleeve during the warming process, the cold guide acts as a cold chamber for the loop during the time of transferring embryo from liquid nitrogen to a warming solution (even if only a couple of seconds). When positioned proximate to a warming solution, the loop can be rapidly extended from the guide and immediately into contact with the warming solution, achieving a high warming rate. Without this cold chamber, an embryo or other cellular specimen may suffer from premature warming by the air when transferring from the liquid nitrogen to a warming solution.

It is appreciated that the cryopreservation systems and devices described herein can be utilized as a closed system or as an open system, according to various embodiments. In a closed system embodiment, the outer sleeve is sealed at both ends when the inner device is contained therein, providing a liquid and/or gas seal. In an open system embodiment, the outer sleeve may include one or more apertures and/or the one or both ends of the outer sleeve may not be completely sealed, allowing liquid and/or gaseous communication between the interior and exterior of the outer sleeve when the inner device is contained therein.

The methods, compositions, and devices described herein are presently representative of embodiments of the invention and are exemplary and are not intended as limitations on the scope of the invention. Changes therein and other uses will occur to those skilled in the art which are encompassed within the spirit. of the invention and are defined by the scope of the disclosure. Accordingly, it will be apparent to one skilled in the art that varying substitutions and modifications may be made to the invention disclosed herein without departing from the scope and spirit of the invention.

What is claimed is:

1. A cryopreservation and storage system comprising:
a) an inner device comprising a longitudinal body having a distal end, a proximal end, and a specimen support located at the distal end of the body of the inner device; and
b) an outer sleeve comprising a longitudinal tube having an inner surface and an outer surface, a distal end, and an open proximal end, and a sample retaining region defined within the longitudinal tube adjacent the distal end, wherein the outer sleeve is adapted to allow the specimen support of the inner device to pass into the sample retaining region and to prevent the specimen support from contacting the distal end of the outer sleeve.

2. The cryopreservation and storage system of claim 1, wherein the outer sleeve includes at least one protruding member on the inner surface that allows the specimen support of the inner device to pass into the sample retaining region and prevents at least a portion of the body of the inner device proximal from the specimen support from passing into the sample retaining region, wherein the sample retaining region exists between the at least one protruding member and the distal end of the outer sleeve.

3. The cryopreservation and storage system of claim 2, wherein the at least one protruding member reduces at least a portion of the inner diameter of the outer sleeve at the location of the at least one protruding member.

4. The cryopreservation and storage system of claim 3, wherein the reduced inner diameter is less than the outer diameter of at least a portion of the body of the inner device proximal from the specimen support.

5. The cryopreservation and storage system of claim 2, wherein the at least one protruding member comprises at least one of: a round member, an elongated member, or an annular member, extending in an inward radial direction from the inner surface of the outer sleeve.

6. The cryopreservation and storage system of claim 1, wherein the inner device is sized to fit completely within the outer sleeve.

7. The cryopreservation and storage system of claim 1, wherein the specimen support of the inner device includes a loop for collecting specimen, and wherein at least a portion of the loop is adapted to pass into the sample retaining region and does not contact the distal end of the outer sleeve.

8. The cryopreservation and storage system of claim 1, wherein the specimen support of the inner device includes a tapered distal end.

9. The cryopreservation and storage system of claim 8, wherein the tapered distal end includes a recessed area for collecting specimen.

10. The cryopreservation and storage system of claim 9, wherein the recessed area forms at least one groove, wherein the at least one groove is approximately perpendicular to a longitudinal axis defined by the longitudinal body of the inner device.

11. The cryopreservation and storage system of claim 9, wherein the recessed area includes a smoothed surface formed by melting at least a portion of the tapered distal end with a heated member.

12. The cryopreservation and storage system of claim 8, wherein at least a portion of the tapered distal end is adapted to pass into the sample retaining region and does not contact the distal end of the outer sleeve.

13. The cryopreservation and storage system of claim 1, wherein the inner device further includes one or more weighted members.

14. The cryopreservation and storage system of claim 1, wherein the inner device further includes one or more ferromagnetic members to facilitate manipulation of the inner device within the outer sleeve when a magnetic force is applied thereto.

15. The cryopreservation and storage system of claim 1, further comprising a guide including a longitudinal guide tube having an open distal end and an open proximal end, wherein the distal end of the guide tube defines a first inner diameter equal to or greater than an outer diameter of the proximal end of the outer sleeve and the proximal end of the guide tube defines a second inner diameter greater than an outer diameter of the inner device, and wherein the second inner diameter is smaller than the outer diameter of the proximal end of the outer sleeve.

16. The cryopreservation and storage system of claim 15, wherein the first inner diameter of the guide tube allows the outer sleeve to be inserted into the distal end of the guide tube and slide within the guide tube until restricted by the second inner diameter, and wherein the first inner diameter and the second inner diameter of the guide tube allow the inner device to be inserted into the distal end of the guide tube and slide freely through and at least partially extend through the proximate end of the guide tube.

17. A cryopreservation and storage method, comprising:
providing an inner device comprising a longitudinal body having a distal end, a proximal end, and a specimen support located at the distal end of the body of the inner device;
providing an outer sleeve comprising a longitudinal tube having an inner surface and an outer surface, a distal end, and an open proximal end, and a sample retaining region defined within the longitudinal tube adjacent the distal end;
collecting at least one specimen from solution with the specimen support of the inner device;
inserting the distal end of the inner device into the proximal end of the outer sleeve, wherein the outer sleeve is adapted to allow the specimen support of the inner device to pass into the sample retaining region and to prevent the specimen support from contacting the distal end of the outer sleeve;
sealing the proximal end and the distal end of the outer sleeve; and
transferring the sealed outer sleeve containing the inner device retaining the at least one specimen into storage medium.

18. The method of claim 17, wherein inserting the inner device into the outer sleeve after collecting the at least one specimen further comprises:
sliding the proximal end of the inner device through a distal end of a guide tube so that the specimen support is positioned within the guide tube;
sliding the proximal end of the outer sleeve into the distal end of the guide tube;
sliding the inner device distally through the guide tube and into the outer sleeve to be contained fully therein; and
removing the guide tube from the outer sleeve.

19. The method of claim 17, further comprising removing the inner device from the storage medium for warming by:
removing the proximal end of the outer sleeve containing the inner device form the storage medium;
opening the proximal end of the outer sleeve;
coupling a distal end of a guide tube to the proximal end of the outer sleeve and allowing the guide tube to cool;
sliding the inner device out of the proximal end of the outer sleeve and into the guide tube so that the specimen support is positioned within the guide tube;
uncoupling the distal end of the guide tube from the proximal end of the outer sleeve; and
sliding the inner device distally to extend at least partially out of the guide tube for transferring the specimen from the specimen support to a warming solution.

20. The method of claim 17, further comprising removing the inner device from the outer sleeve for warming by applying a magnetic force to at least one ferromagnetic member associated with the inner device to maneuver the inner device.
